(19) United States
(12) Patent Application Publication
(10) Pub. No.: US 2023/0218112 A1
(43) Pub. Date: Jul. 13, 2023

(54) DEEP FRYER WITH EXTERNAL WALL HEATING

(71) Applicant: Durmus DEMIR, Izmir (TR)

(72) Inventor: Durmus DEMIR, Izmir (TR)

(21) Appl. No.: 17/997,756

(22) PCT Filed: Aug. 17, 2020
(86) PCT No.: PCT/TR2020/050714

§ 371 Date: Nov. 2, 2022

(51) Int. Cl. A47J 37/12

(52) U.S. Cl. CPC A47J 37/1261; A47J 37/129; A47J 37/1266

(57) ABSTRACT

Disclosed is a deep fryer with a structure which is heated from the external side of the side walls without direct contact of the oil and the heat source that is used to heat the oil in the deep fryers. In particular, the deep fryer includes at least one resistance that provides heating for the side walls, a cold reservoir that is designed to prevent the food residue that sinks to the bottom from burning, and a wave breaker.

### TECHNICAL FIELD

The subject of the invention relates to a deep fryer with a structure which is heated from the external side of the side walls without direct contact of the oil and the heat source that is used to heat the oil in the deep fryers. The subject of the invention particularly relates to the deep fryers which comprise resistance that provide heating the side walls, cold reservoirs that is designed to prevent the food residues that sink to the bottom from burning and wave breakers.

### PRIOR ART

Today, in the industrial deep fryers, internal heating method is used so as to heat the oil. The oil directly contacts the resistor rod which is the heat source and it exchanges heat with a surface with higher temperatures than the temperatures where the oil may remain healthy in the internal heating method. This condition threatens the human health by means of leading to the generation of carcinogenic substances. Meanwhile, it distorts the cooking feature by shortening the life of the oil used.

Industrial type of deep fryers with 18 L capacity in the state of the art are the devices that require power between 9 kW and 16 kW, most of which operate with 380 volts. It reaches to a temperature of 180° C. by operating 25 minutes continuously during the first use and then the thermostat gets involved with the cooling of the oil by the cold food released therein. It requires all power so as to rapidly heat the rapidly cooling oil. A very high capacity of energy is required so as to reach high temperatures since the surface area of the resistance that is in contact with the oil is low. In this case, more than normal heat is required to be spent. As a consequence of this, problems such as extra cost and energy consumption are encountered.

In the known application of the art, the resistance which heats the oil is positioned in the lower/middle portion of the oil reservoir in the industrial deep fryers. The surface temperature of the resistance is required to be 250-300° C. so as to heat the oil completely due to this usage. This leads to the burning of the oil that is in contact with the resistance surface.

The oil tanks used in the known deep fryers in the state of the art consist of chrome basins. The oil is located within a thin and empty reservoir and heated in this region. Since the heat insulation is poor in such a structure, the used oil starts to cool externally while it is tried to be heated internally. As a consequence of this, the oil cannot reach the required temperature and also the heat energy waste is experienced.

Moreover, in the state of the art, the most common problem of all deep fryers is that during cooking process, the undesired food particles (breaded, small particles, flour, crumbs etc.) are distributed in the oil and they distort the quality of the oil due to burning in the hot oil over time. It is required to replace frequently the oil so as to change this matter, thereby leading to an extra cost. In case the oil is not replaced, then the foods which are fried in poor quality oil create a threat for human health.

### AIM OF THE INVENTION

The present invention relates to a deep fryer with external wall heating which is designed such that it can eliminate all disadvantages in the state of the art. It is aimed to provide a deep fryer with the subject of the invention which does not burn the oil and saves electrical energy.

In the inventive deep fryer, the oil is heated externally from the side walls of the reservoir. It is allowed for heating the oil with a controlled temperature since the oil is contact with a wider hot surface. Heating the oil with a balanced temperature prevents the oil from burning and thus from forming carcinogenic substances. Therefore, the used oil does not burn and remains fresh for a longer period of time. It is aimed to extend the economic life of the oil by means of heating the same externally through the side wall.

A cast oil tank is used in the reservoir of the inventive deep fryer. The oil used can be kept in a thick, compact (at the same time heated) reservoir and thus the consequent heat loss is minimized and the heat requirement is reduced by means of benefiting from the natural structure feature of the cast material that is heated rapidly and maintains the heat for a long time. When the tank manufactured from cast iron material is heated, it can both protect its current temperature and balance its own temperature by means of absorbing the heat accumulated on the thick surface of the cast reservoir when the oil comes into contact with the cold food. Therefore, it both saves electrical energy by consuming less electricity and minimizes the heat loss.

It does not matter what material is used in the production of the reservoir that it is open to heat exchanges coming from the external environment. Another feature developed for preventing the heat loss is the isolation of the reservoir externally. Although the iron cast reservoir is used in the invention, a certain heat transfer is always realized externally. Materials with heat insulation feature are used so as to prevent the heat exchange of the iron cast reservoir with the external environment. The oil is maintained constantly hot by means of supporting the heat maintaining features of the cast reservoir. Since the isolation of the reservoir externally reduces the requirement of heating power, it contributes to the electrical energy saving.

In the inventive deep fryer, a second reservoir with a conical structure is formed on the lower portion of the reservoir so as to protect the oil quality by means of preventing the dispersion of the food particles in the oil. The oil in this second reservoir is kept warm (60-130° C.) and the food particles descend over time and it is ensured to keep them in the warm and harmless section of the oil in the secondary reservoir. Since the oil does not burn the food particles, there is nothing in the oil which is burnt, including the broken particles of the cooked food. This is one of the sole factors which protects the quality of oil while extending the economic life of the same.

Another aim of the invention is to protect the mixture of the upper hot oil in the reservoir and the lower cold oil. Thus, the part called wave breaker is placed. This part allows for the food particles to fall down with the vertical walls thereof. Thus, the location of the warm oil at the bottom portion is protected by preventing the completion of the circular hot oil movement.

A heat sensor is placed in the inventive deep fryer so as to obtain the information to be transmitted to the microprocessor by measuring the temperature of the oil within the reservoir. Therefore, it contributes to the electrical energy saving since it is understood whether the ideal temperature is reached or how much heat energy is required.

If we summarize the aims of the invention;
Extending the service life of the oil at least 3 times by preventing the burning of the oil. Especially in fast food restaurants, one of the significant expenses is the frying oils which are required to be changed at most every 3 days. The service life of the oil will be increased at least 3 times with the invention. It prevents agricultural product loss, protects the human health and dramatically reduces the oil expense.
In the prototype tests, when compared to the industrial deep fryers in the state of the art, it is seen that it is provide an electrical energy saving in a ratio of % 40. Moreover, the electrical energy consumed by the deep fryers takes an important place in the expenses of the fast food restaurants.

### DETAILED DESCRIPTION OF THE INVENTION

The inventive deep fryer with external wall heating shall be evaluated according to the following figures in order to better understand the improvements made for reaching the abovementioned aims.

In these figures;

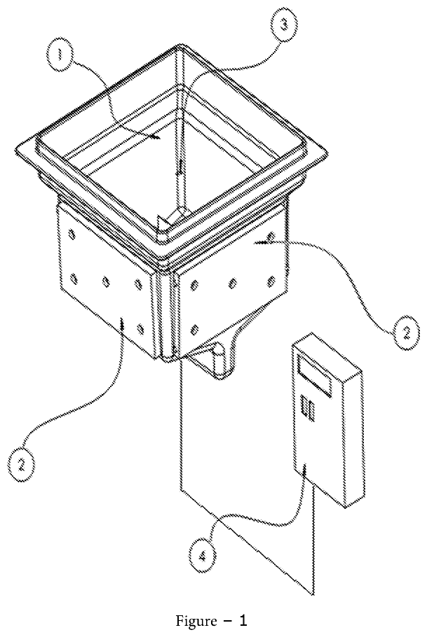

FIG. 1 is a general view of the heating system of the deep fryer

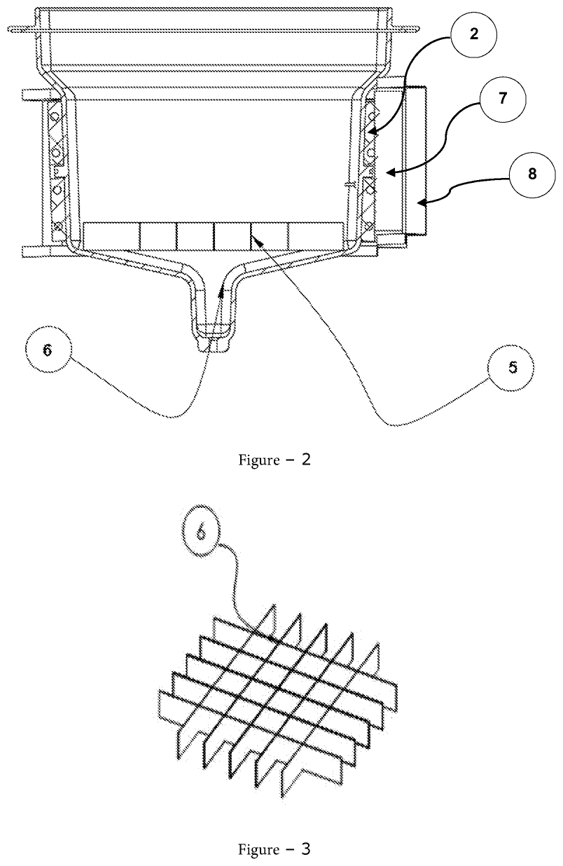

FIG. 2 is a sectional view of the reservoir

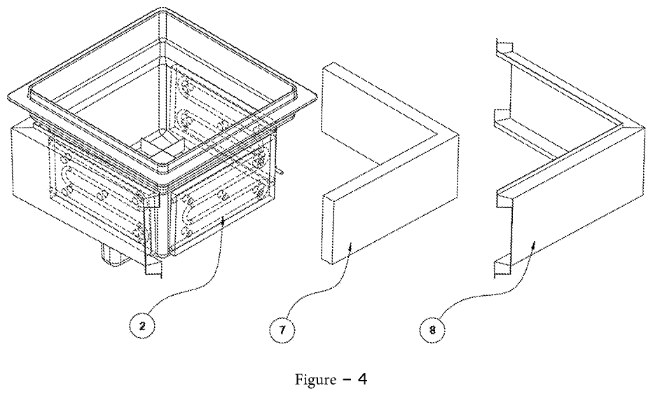

FIG. 3 is a detailed view of the wave breaker

FIG. 4 is an exploded view of the external structure of the heating system of the deep fryer

Numbers are put on the figures in order to make the inventive deep fryer with external wall heating to be understood better. Accordingly;
1. Reservoir
2. Resistance
3. Heat sensor
4. Microprocessor
5. Wave breaker
6. Cold reservoir
7. Insulation material
8. Insulation sheath

The production of the reservoir (1) included in the deep fryer designed for the invention is made from cast material. The reservoir (1) produced from cast material can be heated within a short period of time and the reservoir (1) can disperse its heat to the surface homogenously. A resistance (2) is installed on each of the four sides of the reservoir (1) from its external surfaces. The resistances (2) which are fastened to the external sides of the chamber (1) do not burn the oil, since they do not directly contact with the oil. Furthermore, in the R&D tests performed by way of mounting the resistances (2) on the external side of the reservoir (1), since the surface area expands, it is seen that the required temperatures are reached within a short period of time and the energy is saved. (FIG. 2)

The insulation material (7) which covers the periphery of the reservoir (1) is another aspect which helps energy saving in the deep fryer designed for the invention. The insulation material (1) helps with transferring all the heat provided by the resistance (2) to the reservoir (1). The insulation material (7) that covers the external portion of the resistance (2) is surrounded by an insulation sheath (8) as seen in FIG. 4. The insulation sheath (8) provides the used insulation material (7) to remain stable around the resistance (2).

The heat sensor (3) located on the internal surface of the reservoir (1) is a sensor which has a sensitivity of one tenth of a degree. The heat sensor (3) which is compatible with the computers is connected with the microprocessor (4). The heat sensor (3) is an advanced technological product which can transfer very sensitive and instant values to the microprocessor (4). The heat sensor (3) transfers the instant temperature data of the oil within the reservoir (1) to the microprocessor (4) six times a second with a sensitivity of one tenth of a degree. (FIG. 1)

The microprocessor (4) controls the resistances (2) via the data received from the heat sensor (3). It manages the resistances (2) by means of the software created for microprocessor (4), it makes the most optimal oil temperature and energy consumption possible in any case. The resistances (2) that are not required to operate can be turned off by means of the software of the microprocessor (4) by considering the data of the oil temperature received from the heat sensor (2).

There is a cold reservoir (6) formed at the lower portion of the reservoir (1). The cold reservoir (6) is a secondary reservoir contained in the deep fryer. The particles (breaded, small particles, flour, crumbs etc.) of the food which is cooked in the reservoir (1) pass to the cold chamber (6) located at the lower portion of the reservoir (1). There is warm oil in the cold reservoir (6) in contrast to the reservoir (1). The food particles trapped in the cold reservoir (6) are prevented from burning within the oil and the quality of the oil is protected. The cold reservoir (6) may have preferably a conical shape but also may have another geometric shape.

In the R&D test studies realized in the inventive designed deep fryer, when the cooking basket of the fryer is immersed into the reservoir (1), the hot oil remains in the upper/middle portion of the reservoir (1) creates turbulence within the reservoir by ascending and descending up/down with circular movements. This condition causes mixture of the hot oil within the reservoir (1) and the warm oil within the cold reservoir (6) placed below. Therefore, the oil which is at the upper portion and is required to be hot cools down and affects the cooking ability of the deep fryer negatively. In addition to this, it places the food particles passed in the cold reservoir (6) into the reservoir (1) section and this causes negative consequences as they are burnt in the hot oil. A wave breaker (5) is positioned between the reservoir (1) and the cold reservoir (6) so as to solve this technical problem. The wave breaker (5) in FIG. 3 prevents the mixture of the warm oil within the cold reservoir (6) located at the lower portion of the deep fryer and the hot oil within the reservoir (1) at the upper portion. It is observed that the optimum results in the R&D studies performed are achieved when the wave breaker (5) model is with a grid-structure. The wave breaker (5) that prevents the mixture of the warm and hot oil to each other protects the food cooking ability of the deep fryer. Moreover, it helps the food particles that fall into the cold reservoir (6) to remain within the cold reservoir (6).

1. A heating system used in deep fryers, comprising at least one resistance which is engaged to at least one of the external sides of a reservoir.

2. The heating system of claim 1, wherein the reservoir comprises at least one heat sensor which is positioned on the an internal surface of said reservoir.

3. The heating system of claim 2, wherein the deep fryer comprises at least one microprocessor which is connected with the heat sensor and has software that can give an on/off command to the at least one resistance with the help of the software it has.

4. The heating system of claim 1, wherein the reservoir comprises at least one cold reservoir which is formed at the bottom portion of said reservoir and in which food particles are trapped.

5. The heating system of claim 4, wherein the reservoir comprises at least one wave breaker which is positioned between said reservoir and the cold reservoir and prevents the passage of hot and warm oil.

6. The heating system of claim 4, wherein the cold reservoir has a conical structure.

7. The heating system of claim 1, wherein the reservoir is produced from cast material which can be heated in a short period of time and can disperse the heat to the surface homogenously.

8. The heating system of claim 3, wherein the heat sensor transmits data to the microprocessor six times a second.

9. The heating system of claim 2, wherein the heat sensor has a one-tenth degree sensitivity.

10. The heating system of claim 1, wherein the resistance has at least one insulation material located on its external surface.

11. The heating system of claim 10, wherein the insulation material comprises at least one insulation sheath which is fixed on the external surface of the resistance and is positioned along the external surface of said insulation material.

12. The heating system of claim 5, wherein the wave breaker has a grid structure.
